(19) United States
(12) Patent Application Publication
(10) Pub. No.: US 2025/0024555 A1
(43) Pub. Date: Jan. 16, 2025

(54) METHOD FOR WIRELESS COMMUNICATION AND DEVICES THEREOF

(71) Applicant: ZTE CORPORATION, Shenzhen (CN)

(72) Inventors: Xiubin SHA, Shenzhen (CN); He HUANG, Shenzhen (CN); Bo DAI, Shenzhen (CN); Li ZHANG, Shenzhen (CN); Yuan GAO, Shenzhen (CN); Eswar Kalyan VUTUKURI, Shenzhen (CN)

(73) Assignee: ZTE CORPORATION, Shenzhen (CN)

(21) Appl. No.: 18/898,945

(22) Filed: Sep. 27, 2024

Related U.S. Application Data
(63) Continuation of application No. PCT/CN2022/139792, filed on Dec. 16, 2022.

(51) Int. Cl. H04W 76/28

(52) U.S. Cl. CPC H04W 76/28

(57) ABSTRACT

A wireless communication method for use in a wireless terminal is disclosed. The method comprises receiving, from a wireless network node, configuration information of a connected mode discontinuous reception (C-DRX), wherein the configuration information indicates a non-integer periodicity, and performing the C-DRX based on the non-integer periodicity.

### CROSS-REFERENCE TO RELATED APPLICATION

This application claims the benefit of priority under 35 U.S.C. § 120 as a continuation of International Patent Application No. PCT/CN2022/139792, filed on Dec. 16, 2022, the disclosure of which is incorporated herein by reference in its entirety.

### TECHNICAL FIELD

This document is directed generally to wireless communications, in particular, 5^{th} generation wireless communications, and in particular to a configuration of discontinuous reception (DRX).

### BACKGROUND

Because XR (extended reality) services usually are a quasi-periodicity services with burst arrive time jitter, a C-DRX (connected mode DRX) may be used to match the burst arrive pattern of the XR services and save UE (user equipment) power. That is the UE monitors a PDCCH (physical downlink control channel) to transmit and/or to receive XR data during an active time duration (e.g., when an on-duration timer is running) of the C-DRX, and the UE stops monitoring the PDCCH for power saving during an inactive time of the C-DRX. To apply the C-DRX for the XR services, there may be certain aspects needed to be considered.

### SUMMARY

This document relates to methods, systems, and devices for configuring the C-DRX and in particular to methods, systems, and devices for the C-DRX with a burst transmission pattern.

The present disclosure relates to a wireless communication method for use in a wireless terminal. The method comprises:
receiving, from a wireless network node, configuration information of a connected mode discontinuous reception (C-DRX), wherein the configuration information indicates a non-integer periodicity, and
performing the C-DRX based on the non-integer periodicity.

Various embodiments may preferably implement the following features:

Preferably or in some embodiments, the configuration information indicates the fractional periodicity by indicating a fractional value of the fractional periodicity.

Preferably or in some embodiments, the configuration information indicates the fractional periodicity by indicating a fractional value of the fractional periodicity.

Preferably or in some embodiments, the configuration information indicates the fractional periodicity by indicating a numerator and a denominator.

Preferably or in some embodiments, the configuration information indicates the non-integer periodicity by indicating a data burst frequency (e.g., with unit of fps (frame per second) or Hz), and the non-integer periodicity=1000 ms/data burst frequency.

Preferably or in some embodiments, performing the C-DRX based on the non-integer periodicity comprises determining a C-DRX on-duration start occasion, e.g., based on the non-integer periodicity.

Preferably or in some embodiments, the C-DRX on-duration start occasion is determined based on:

$$floor ( [ ( ( 1024 \times m + SFN ) \times 10 ) + subframe\_number ] modulo ( drx - periodicity ) ) = \text{} floor ( [ \text{} ( ( {SFN}_{start time} ) \times 10 ) + {subframe}_{start time} ] modulo ( drx - periodicity ) ) ,$$

wherein m=0 when the C-DRX is activated and is incremented every time SFN=0, SFN is a system frame number of the C-DRX on-duration start occasion, subframe_number is a subframe number of the C-DRX on-duration start occasion, drx−periodicity is the non-integer periodicity, SFN_{start time} is a system frame number of a 1^{st} C-DRX on-duration start occasion, and subframe_{start time} is a subframe number of the 1^{st} C-DRX on-duration start occasion.

Preferably or in some embodiments, the C-DRX on-duration start occasion is determined based on:

$$floor ( [ ( ( 1024 \times m + SFN ) \times 10 ) + subframe\_number ] modulo ( drx - periodicity ) ) = \text{} floor ( [ ( ( timeReferenceSFN ) \times 10 ) - timeDomainOffset ] modulo ( drx - periodicity ) ) ,$$

wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and timeReferenceSFN and timeDomainOffset are indicated in the configuration information of the C-DRX to determine the 1^{st} C-DRX on-duration start occasion.

Preferably or in some embodiments, the C-DRX on-duration start occasion is determined based on:

$$floor [ ( ( 1024 \times m + SFN ) \times 10 ) + subframe\_number ] modulo ( drx - periodicity ) = drx - StartOffset ,$$

wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.

Preferably or in some embodiments, the C-DRX on-duration start occasion is determined based on:

$$floor ( [ ( ( 1024 \times m + SFN ) \times 10 ) + subframe\_number ] modulo ( drx - periodicity ) ) = drx - StartOffset ,$$

wherein m=0 when the C-DRX is activated and is incremented every time SFN=0, SFN is the system frame number of the C-DRX on-duration start occasion, numberOfSlotsPerFrame is a number of slots per frame, slot_number is a slot number of the C-DRX on-duration start occasion, drx−periodicity is the non-integer periodicity, SFN_{start time} is a system frame number of the 1^{st} C-DRX on-duration start occasion, and slot_{start time} is a slot number of the 1^{st} C-DRX on-duration start occasion.

Preferably or in some embodiments, the C-DRX on-duration start occasion is determined based on:

$$floor ( [ ( ( 1024 \times m + SFN ) \times numberOfSlotsPerFrame \times numberOfSymbolsPerSlot \times 10 ) + ( slot\_number \times numberOfSymbolsPerSlot ) + symbol\_number ] modulo ( ( drx - periodicity ) \times numberOfSlotsPerFrame \times numberOfSymbolsPerSlot \div 10 ) ) = floor ( [ ( ( {SFN}_{start time} ) \times numberOfSlotsPerFrame \times numberOfSymbolsPerSlot \times 10 ) + ( {slot}_{start time} \times numberOfSymbolsPerSlot ) + {symbol}_{start time} ] modulo ( ( drx - periodicity ) \times numberOfSlotsPerFrame \times numberOfSymbolsPerSlot \div 10 ) ) ,$$

wherein m=0 when the C-DRX is activated and is incremented every time SFN=0, SFN is the system frame number of the C-DRX on-duration start occasion, numberOfSlotsPerFrame is the number of slots per frame, slot_number is a slot number of the C-DRX on-duration start occasion, symbol_number is a symbol number of the C-DRX on-duration start occasion, drx−periodicity is the non-integer periodicity, SFN_{start time} is a system frame number of the 1^{st} C-DRX on-duration start occasion, slot_{start time} is a slot number of the 1^{st} C-DRX on-duration start occasion and symbol_{start time} is a symbol number of the 1^{st} C-DRX on-duration start occasion.

Preferably or in some embodiments, the C-DRX on-duration start occasion is determined based on:

$$[ ( SFN \times 10 ) + subframe\_number ] = ceil ( [ ( drx - timeReference SFN ) \times 10 - timeDomainOffset + N \times ( drx - periodicity ) ] modulo ( 10240 ) ) ,$$

wherein SFN is the system frame number of the C-DRX on-duration start occasion, subframe_number is a subframe number of the C-DRX on-duration start occasion, drx−timeReferenceSFN and timeDomainOffset are indicated in the configuration information of the C-DRX and drx−periodicity is the non-integer periodicity.

Preferably or in some embodiments, the C-DRX on-duration start occasion is determined based on:

$$[ ( SFN \times 10 ) + subframe\_number ] = ceil ( [ {SFN}_{starttime} \times 10 + {subframe}_{starttime} + N \times ( drx - periodicity ) ] modulo ( 10240 ) ) ,$$

where SFN_{start time} and subframe_{start time} are respectively the SFN and subframe number of the first (1^{st}) C-DRX on-duration start occasion; drx−periodicity is the (non-integer or fractional) periodicity of the C-DRX; N is an integer greater than or equal to 0, SFN_{start time} and subframe_{start time} are indicated in the configuration information of the C-DRX.

Preferably or in some embodiments, the configuration information comprises indication information associated with determining the 1^{st} C-DRX on-duration start occasion.

Preferably or in some embodiments, the indication information comprises a least-significant bit of a hyper system frame number associated with a 1^{st} transmission of a radio resource control signaling comprising the configuration information.

Preferably or in some embodiments, the indication information comprises a reference system frame number and a time-domain offset, and the 1^{st} C-DRX on-duration start occasion starts at a time-domain location which is the time-domain offset before or after the reference system frame number.

Preferably or in some embodiments, the indication information comprises a reference system frame number indicating a closest system frame number preceding or following the 1^{st} C-DRX on-duration start occasion and a start offset indicating a time-domain location of the 1^{st} C-DRX on-duration start occasion based on the closest system frame number.

The present disclosure relates to a wireless communication method for use in a wireless network node. The method comprises:
transmitting, to a wireless terminal, configuration information of a connected mode discontinuous reception (C-DRX), wherein the configuration information indicates a non-integer periodicity, and
transmitting, to the wireless terminal, data based on the C-DRX with the non-integer periodicity.

Various embodiments may preferably implement the following features:

Preferably or in some embodiments, the configuration information indicates the fractional periodicity by indicating a fractional value of the fractional periodicity.

Preferably or in some embodiments, the configuration information indicates the fractional periodicity by indicating a fractional value of the fractional periodicity.

Preferably or in some embodiments, the configuration information indicates the fractional periodicity by indicating a numerator and a denominator.

Preferably or in some embodiments, the configuration information indicates the non-integer periodicity by indicating a data burst frequency (e.g. with unit of fps or Hz), and the the non-integer periodicity=1000 ms/data burst frequency.

Preferably or in some embodiments, transmitting, to the wireless terminal, data based on the C-DRX with the non-integer periodicity comprises determining a C-DRX on-duration start occasion, e.g., based on the non-integer periodicity.

Preferably or in some embodiments, the C-DRX on-duration start occasion is determined based on:

$$floor [ ( ( 1024 \times m + SFN ) \times 10 ) + subframe\_number ] modulo ( drx - periodicity ) ) = floor ( [ ( ( {SFN}_{start time} ) \times 10 ) + {subframe}_{start time} ] modulo ( drx - periodicity ) ) ,$$

wherein m=0 when the C-DRX is activated and is incremented every time SFN=0, SFN is a system frame number of the C-DRX on-duration start occasion, subframe_number is a subframe number of the C-DRX on-duration start occasion, drx−periodicity is the non-integer periodicity, SFN_{start time} is a system frame number of a 1^{st} C-DRX on-duration start occasion, and subframe_{start time} is a subframe number of the 1^{st} C-DRX on-duration start occasion.

Preferably or in some embodiments, the C-DRX on-duration start occasion is determined based on:

$$floor [ ( ( 1024 \times m + SFN ) \times 10 ) + subframe\_number ] modulo ( drx - periodicity ) ) = floor ( [ ( ( timeReference SFN ) \times 10 ) - timeDomainOffset ] modulo ( drx - periodicity ) ) ,$$

wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and timeReferenceSFN and timeDomainOffset are indicated in the configuration information of the C-DRX to determine the 1^{st} C-DRX on-duration start occasion.

Preferably or in some embodiments, the C-DRX on-duration start occasion is determined based on:

$$floor [ ( ( 1024 \times m + SFN ) \times 10 ) + subframe\_number ] modula ( drx - periodicity ) ) = drx - StartOffset ,$$

wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.

Preferably or in some embodiments, the C-DRX on-duration start occasion is determined based on:

$$floor ( [ ( ( 1024 \times m + SNF ) \times numberOfSlotsPerFrame \times 10 ) + slot\_number ] modulo ( ( drx - periodicity ) \times numberOfSlotsPerFrame \div 10 ) ) = floor ( [ ( ( {SFN}_{start time} ) \times numberOfSlotsPerFrame \times 10 ) + {slot}_{start time} ] modulo ( ( drx - periodicity ) \times numberOfSlotsPerFrame \div 10 ) ) ,$$

wherein m=0 when the C-DRX is activated and is incremented every time SFN=0, SFN is the system frame number of the C-DRX on-duration start occasion, numberOfSlotsPerFrame is a number of slots per frame, slot_number is a slot number of the C-DRX on-duration start occasion, drx−periodicity is the non-integer periodicity, SFN_{start time} is a system frame number of the 1^{st} C-DRX on-duration start occasion, and slot_{start time} is a slot number of the 1^{st} C-DRX on-duration start occasion.

Preferably or in some embodiments, the C-DRX on-duration start occasion is determined based on:

$$floor ( [ ( ( 1024 \times m + SFN ) \times numberOfSlotsPerFrame \times numberOSymbolsPerSlot \times 10 ) + ( slot\_number \times numberOfSymbolsPerSlot ) + symbol\_number ] modula ( ( drx - periodicity ) \times numberOfSlotsPerFrame \times numberOfSymbolsPerSlot \div 10 ) ) = floor ( [ ( ( {SFN}_{start time} ) \times numberOfSlotsPerFrame \times numberOfSymbolsPerSlot \times 10 ) + ( {slot}_{start time} \times numberOfSymbolsPerSlot ) + {symbol}_{start time} ] modula ( ( drx - periodicity ) \times numberOfSlotsPerFrame \times numberOfSymbolsPerSlot \div 10 ) ) ,$$

wherein m=0 when the C-DRX is activated and is incremented every time SFN=0, SFN is the system frame number of the C-DRX on-duration start occasion, numberOfSlotsPerFrame is the number of slots per frame, slot_number is a slot number of the C-DRX on-duration start occasion, symbol_number is a symbol number of the C-DRX on-duration start occasion, drx−periodicity is the non-integer periodicity, SFN_{start time} is a system frame number of the 1^{st} C-DRX on-duration start occasion, slot_{start time} is a slot number of the 1^{st} C-DRX on-duration start occasion and symbol_{start time} is a symbol number of the 1^{st} C-DRX on-duration start occasion.

Preferably or in some embodiments, the C-DRX on-duration start occasion is determined based on:

$$[ ( SFN \times 10 ) + subframe\_number ] = ceil ( [ ( drx - timeReference SFN ) \times 10 - timeDomainOffset + N \times ( drx - periodicity ) ] modula ( 10240 ) ) ,$$

wherein SFN is the system frame number of the C-DRX on-duration start occasion, subframe_number is a subframe number of the C-DRX on-duration start occasion, drx−timeReferenceSFN and timeDomainOffset are indicated in the configuration information of the C-DRX and drx−periodicity is the non-integer periodicity.

Preferably or in some embodiments, the C-DRX on-duration start occasion is determined based on:

$$[ ( SFN \times 10 ) + subframe\_number ] = ceil ( [ ( {SFN}_{starttime} \times 10 + {subframe}_{starttime} + N \times ( drx - periodicity ) ] modula ( 10240 ) ) ,$$

where SFN_{start time} and subframe_{start time} are respectively the SFN and subframe number of the first (1^{st}) C-DRX on-duration start occasion; drx−periodicity is the (non-integer or fractional) periodicity of the C-DRX; N is an integer greater than or equal to 0, SFN_{start time}and subframe_{start time} are indicated in the configuration information of the C-DRX.

Preferably or in some embodiments, the configuration information comprises indication information associated with determining the 1^{st} C-DRX on-duration start occasion.

Preferably or in some embodiments, the indication information comprises a least-significant bit of a hyper system frame number associated with a 1^{st} transmission of a radio resource control signaling comprising the configuration information.

Preferably or in some embodiments, the indication information comprises a reference system frame number and a time-domain offset, and the 1^{st} C-DRX on-duration start occasion starts at a time-domain location which is the time-domain offset before or after the reference system frame number.

Preferably or in some embodiments, the indication information comprises a reference system frame number indicating a closest system frame number preceding or following the 1^{st} C-DRX on-duration start occasion and a start offset indicating a time-domain location of the 1^{st} C-DRX on-duration start occasion based on the closest system frame number.

The present disclosure relates to a wireless communication method for use in a wireless network node. The method comprises:
transmitting, to a wireless terminal, configuration information of a connected mode discontinuous reception (C-DRX), wherein the configuration information indicates a non-integer periodicity, and
transmitting, to the wireless terminal, data based on the C-DRX with the non-integer periodicity.

The present disclosure relates to wireless communication method for use in a wireless terminal. The method comprises determining at least one hybrid automatic repeat request process (HARQ) process identifier (ID) from a HARQ process ID range for a plurality of configured grant (CG) resource occasions in a period.

Various embodiments may preferably implement the following features:

Preferably or in some embodiments, the HARQ process ID is determined per CG resource occasion.

Preferably or in some embodiments, the wireless communication method further comprises transmitting, to a wireless network node, indication of the determined at least one HARQ process ID along with uplink transmissions over the CG resource occasions.

Preferably or in some embodiments, the HARQ process ID is determined per period.

Preferably or in some embodiments, the HARQ process ID is determined by:

$$HARQ process ID = [ floor ( CURRENT\_SYMBOL / periodicity ) ] modulo ( nrofHARQ - Processes ) + ( harq - ProcID - Offset ) , wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the HARQ process ID is determined per transmission over the CG resource occasions.

Preferably or in some embodiments, the HARQ process ID is determined by:

$$HARQ process ID = [ floor ( CURRENT\_SYMBOL / CG\_occasion \_interval ) ] modulo ( nrofHARQ - Processes ) + ( harq - ProcID - Offset ) , wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, CG_occasion_interval is an interval between two contiguous CG occasions, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the HARQ process ID of a first CG occasion in the plurality of CG occasions is determined based on a sequence number of the first CG occasion.

Preferably or in some embodiments, the HARQ process ID is determined by:

$$HARQ process ID = CG\_occasion \_SequenceNumber modulo ( nrofHARQ - Processes ) + ( harq - ProcID - Offset )$$

where CG_occasion_SequenceNumber is the sequence number, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the period is a CG occasion period or a connected-mode discontinuous reception period.

The present disclosure relates to a wireless communication method for use in a wireless network node. The method comprises determining at least one hybrid automatic repeat request process (HARQ) process identifier (ID) from a HARQ process ID range for a plurality of configured grant (CG) resource occasions in a period.

Various embodiments may preferably implement the following features:

Preferably or in some embodiments, the HARQ process ID is determined per CG resource occasion.

Preferably or in some embodiments, the wireless communication method further comprises receiving, from a wireless terminal, indication of the at least one HARQ process ID along with uplink transmissions over the CG resource occasions, wherein the at least HARQ process ID is determined based on the indication.

Preferably or in some embodiments, the HARQ process ID is determined per period.

Preferably or in some embodiments, the HARQ process ID is determined by:

$$HARQ process ID = [ floor ( CURRENT\_SYMBOL / periodicity ) ] modulo ( nrofHARQ - Processes ) + ( harq - ProcID - Offset ) , wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the HARQ process ID is determined per transmission over the CG resource occasions.

Preferably or in some embodiments, the HARQ process ID is determined by:

$$HARQ process ID =$$

$$[ floor ( CURRENT\_SYMBOL / CG\_occasion \_interval ) ]$$

$$modulo ( nrofHARQ - Processes ) + ( harq - ProcID - Offset ) ,$$

$$wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, CG_occasion_interval is an interval between two contiguous CG occasions, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the HARQ process ID of a first CG occasion in the plurality of CG occasions is determined based on a sequence number of the first CG occasion.

Preferably or in some embodiments, the HARQ process ID is determined by:

$$HARQ process ID = CG\_occasion \_SequenceNumber modulo ( nrofHARQ - Processes ) + ( harq - ProcID - Offset )$$

where CG_occasion_SequenceNumber is the sequence number, nrofHARQ−Processes is a number of HARQ process IDs configured for the plurality of CG resource occasions, and harq−ProcID−Offset is a 1^{st} HARQ process ID configured for the plurality of CG resource occasions.

Preferably or in some embodiments, the period is a CG occasion period or a connected-mode discontinuous reception period.

The present disclosure relates to a wireless terminal. The wireless terminal comprises:
a communication unit, configured to receive, from a wireless network node, configuration information of a connected mode discontinuous reception (C-DRX), wherein the configuration information indicates a non-integer periodicity, and
a processor configured to perform the C-DRX based on the non-integer periodicity.

Various embodiments may preferably implement the following feature:

Preferably or in some embodiments, the processor is further configured to perform any of the aforementioned wireless communication methods.

The present disclosure relates to a wireless network node. The wireless network node comprises a communication unit, configured to:
transmit, to a wireless terminal, configuration information of a connected mode discontinuous reception (C-DRX), wherein the configuration information indicates a non-integer periodicity, and
transmit, to the wireless terminal, data based on the C-DRX with the non-integer periodicity.

Various embodiments may preferably implement the following feature:

Preferably or in some embodiments, the wireless network node further comprises a processor configured to perform any of the aforementioned wireless communication methods.

The present disclosure relates to a wireless terminal. The wireless terminal comprises:
a processor, configured to determine at least one hybrid automatic repeat request process (HARQ) process identifier (ID) from a HARQ process ID range for a plurality of configured grant (CG) resource occasions in a period.

Various embodiments may preferably implement the following feature:

Preferably or in some embodiments, the processor is further configured to perform any of aforementioned wireless communication methods.

The present disclosure relates to a wireless network node. The wireless network node comprises:
a processor, configured to determine at least one hybrid automatic repeat request process (HARQ) process identifier (ID) from a HARQ process ID range for a plurality of configured grant (CG) resource occasions in a period.

Various embodiments may preferably implement the following feature:

Preferably or in some embodiments, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE FIGURES

FIG. 1 shows a schematic diagram of a mismatch between XR traffic arrival times and DRX cycles after the SFN wrap around according to an embodiment of the present disclosure.

FIG. 2 shows a schematic diagram of a uplink transmission according to an embodiment of the present disclosure.

FIG. 3 shows a schematic diagram of a uplink transmission according to an embodiment of the present disclosure.

FIG. 4 shows a schematic diagram of a uplink transmission according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 shows a schematic diagram of a wireless communication system according to an embodiment of the present disclosure.

FIG. 8 shows a flowchart of a method according to an embodiment of the present disclosure.

FIG. 9 shows a flowchart of a method according to an embodiment of the present disclosure.

FIG. 10 shows a flowchart of a method according to an embodiment of the present disclosure.

### DETAILED DESCRIPTION

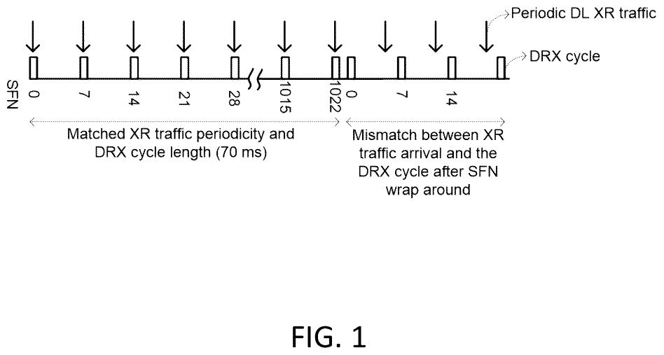

In an embodiment, the frame rates (e.g., 15 fps (frame per second), 30 fps, 45 fps, 60 fps, 72 fps, 90 fps and 120 fps) of the XR services respectively correspond to periodicities of (66.66 ms (micro second), 33.33 ms, 22.22 ms, 16.66 ms, 13.88 ms, 11.11 ms and 8.33 ms) which are not multiples of the C-DRX periodicity (e.g., the C-DRX periodicity may be configured in the unit of ms) and are not an integer factor of 1024 ms. Under such conditions, there would be a mismatch between the XR service periodicity and the DRX cycle because of the periodicity mismatch and SFN (system frame number) wrap around issue. FIG. 1 shows a schematic diagram of a mismatch between XR traffic arrival times and DRX cycles after the SFN wrap around according to an embodiment of the present disclosure. As shown in FIG. 1, the mismatch between the XR service periodicity and the DRX cycle may cause the DRX cycle out of synchronization with the arrival time of the XR traffic after the SFN wrap around.

The present disclosure provides methods for the C-DRX applied for the XR services and devices thereof. Note that the methods disclosed in the present disclosure may be applied for Configured Scheduling mechanisms for uplink (e.g., CG (configured grant)) and/or for downlink (e.g., SPS (semi-persistent scheduling)). In addition, the C-DRX in the present disclosure is not limited to the XR services and may also be applied for other types of services.

### C-DRX Periodicity Configuration

In an embodiment, the XR frame rates (e.g., 15 fps, 30 fps, 45 fps, 60 fps, 72 fps, 90 fps and 120 fps) correspond to periodicity of (e.g., 200/3 ms, 100/3 ms, 200/9 ms, 50/3 ms, 125/9 ms, 100/9 ms, 3/25 ms respectively). To align the CDRX periodicity with the XR frame rate, the XR frame rate (e.g., data burst frequency), such as, e.g., 15, 30, 45, 60, 72, 90 and 120 fps, is configured to the UE and the UE calculates the C-DRX periodicity or CG/SPS periodicity with the formula of 1000 ms/XR frame rate (e.g., the XR frame rate may be data burst frequency); or a non-integer periodicity (e.g., Fractional periodicity) is configured as the C-DRX periodicity.

In an embodiment, the Fractional periodicity can be presented by enumerated with Fractional values. For example, the Fractional periodicity can be presented by enumerated with Fractional values as the following pseudo code:

Periodicity ENUMERATED {3 per 200 ms, 3 per 100 ms, 9 per 200 ms, 3 per 50 ms, 9 per 125 ms, 9 per 100 ms, 3 per 25 ms}

Note that 3 per 200 ms indicates the periodicity of 200/3 ms, 3 per 100 ms indicates the periodicity of 100/3 ms and so on.

As an alternative or in addition, the Fractional periodicity is presented by (indicating) a numerator and a denominator. For instance, the Fractional periodicity may be presented by the numerator and the denominator as following pseudo code:

Periodicity::=SEQUENCE {numerator ENUMERATED{25, 50, 100, 125, 200}denominator ENUMERATED{3, 9},}

In this embodiment, the periodicity is indicated as (numerator/denominator) ms.

In an embodiment, the non-integer (e.g., fractional) periodicity configuration method for the C-DRX can also be used for configuring non-integer (e.g., fractional) periodicity for the CG and/or the SPS.

### The SFN and Subframe of C-DRX On-Duration Start Occasion

In some embodiments, the C-DRX on-duration start occasion is determined based on the XR (non-integrity) periodicity, to eliminate the mismatch between the CDRX periodicity and the XR non-integrity periodicity and avoid the SFN wraparound issue.

In an embodiment, the SFN and Subframe number of a C-DRX on-duration start occasion can be determined by:

$$floor ( [ ( ( 1024 \times m + SFN ) \times 10 ) + subframe\_number ] modulo ( drx - periodicity ) ) = floor ( [ ( ( {SFN}_{start time} ) \times 10 ) + {subframe}_{start time} ] modulo ( drx - periodicity ) ) , \qquad ( EQ 2 - 1 )$$

where m=0 when the C-DRX is activated and is incremented every time SFN=0; SFN is the SFN of the C-DRX on duration start occasion, subframe_number is the subframe number of the C-DRX on duration start occasion, SFN_{start time} and subframe_{start time} are respectively the SFN and Subframe of the first (1^{st}) C-DRX on-duration start occasion; and drx−periodicity is the (non-integer or fractional) periodicity of the C-DRX. In an embodiment, the SFN_{start time} and subframe_{start time} are indicated explicitly when/if the C-DRX is activated.

In an embodiment, the SFN and subframe number/index of a C-DRX on-duration start occasion can be determined by:

$$floor ( [ ( ( 1024 \times m + SFN ) \times 10 ) + subframe\_number ] modulo ( drx - periodicity ) ) = floor ( [ ( ( timeReferenceSFN ) \times 10 ) - timeDomainOffset ] modulo ( drx - periodicity ) ) , \qquad ( EQ 2 - 2 )$$

where m=0 when the C-DRX is activated and is incremented every time SFN=0, SFN is the SFN of the C-DRX on-duration start occasion, subframe_number is the subframe number of the C-DRX on-duration start occasion, drx−periodicity is the non-integer periodicity, and timeReferenceSFN and timeReferenceSFN are indicated in the configuration information of the C-DRX and/or are used to determine the 1st C-DRX on-duration start occasion.

In an embodiment, the SFN and subframe number of a C-DRX on-duration start occasion can be determined by:

$$floor ( [ ( ( 1024 \times m + SFN ) \times 10 ) + subframe\_number ] modulo ( drx - periodicity ) ) = drx - StartOffset , \qquad ( EQ 2 - 3 )$$

where m=0 when C-DRX is activated and is incremented every time SFN=0, SFN is the SFN of the C-DRX on-duration start occasion, subframe_number is the subframe number of the C-DRX on-duration start occasion, drx−StartOffset is indicated explicitly when the C-DRX is activated which is used to determine the SFN and Subframe of the C-DRX on-duration start occasion; and drx-periodicity is the (non-integer or fractional) periodicity of the C-DRX.

In an embodiment, the SFN and a slot number of a C-DRX on-duration start occasion can be determined by:

$$floor ( [ ( ( 1024 \times m + SFN ) \times numberOfSlotsPerFrame \times 10 ) + \qquad ( EQ 2 - 4 )$$

$$slot\_number ] modulo ( ( drx - periodicity ) \times$$

$$numberOfSlotsPerFrame \div 10 ) ) =$$

$$floor ( [ ( ( {SFN}_{start time} ) \times numberOfSlotsPerFrame \times 10 ) + {slot}_{start time} ]$$

$$modulo ( ( drx - periodicity ) \times numberOfSlotsPerFrame \div 10 ) ) ,$$

where m=0 when the C-DRX is activated and is incremented every time SFN=0; SFN is the SFN of the C-DRX on-duration start occasion, slot_number is the slot number of the C-DRX on-duration start occasion, SFN_{start time} and slot_{start time} are respectively the SFN and the slot number of the first (1^{st}) C-DRX on-duration start occasion where the C-DRX is (re-)configured or activated; and drx−periodicity is the (non-integer or fractional) periodicity of the C-DRX. In this embodiment, the SFN_{start time} and slot_{start time} may be explicitly indicated (e.g., by the network or base station) if the C-DRX is (re-)configured or activated or (re-)configured.

In an embodiment, the SFN, slot number and symbol number of a C-DRX on-duration start occasion can be determined by:

$$floor ( [ ( ( 1024 \times m + SFN ) \times numberOfSlotsPerFrame \times numberOfSymbolsPerSlot \times 10 ) + ( slot\_number \times numberOfSymbolsPerSlot ) + symbol\_number ] modulo ( ( drx - periodicity ) \times numberOfSlotsPerFrame \times numberOfSymbolsPerSlot \div 10 ) ) = floor ( [ ( ( {SFN}_{start time} ) \times numberOfSlotsPerFrame \times numberOfSymbolsPerSlot \times 10 ) + ( {slot}_{start time} \times numberOfSymbolsPerSlot ) + {symbol}_{start time} ] modulo ( ( drx - periodicity ) \times numberOfSlotsPerFrame \times numberOfSymbolsPerSlot \div 10 ) ) , \qquad ( EQ 2 - 5 )$$

where m=0 when the C-DRX is activated and is incremented every time SFN=0; SFN is the SFN of the C-DRX on-duration start occasion, slot_number is the slot number of the C-DRX on-duration start occasion, symbol_number is the symbol number of the C-DRX on-duration start occasion, SFN_{start time}, slot_{start time} and symbol_{start time} are respectively the SFN, slot number and symbol number of the first (1^{st}) C-DRX on-duration start occasion; and drx-periodicity is the (non-integer or fractional) periodicity of the C-DRX. In this embodiment, the SFN_{start time}, slot_{start time} and symbol_{start time} may be explicitly indicated when/if the C-DRX is activated or (re-)configured.

In an embodiment, the SFN and the subframe number of the C-DRX on-duration start occasion can be determined by:

$$[ ( SFN \times 10 ) + subframe\_number ] = ceil ( [ ( timeReferenceSFN ) \times 10 - timeDomainOffset + N \times ( drx - periodicity ) ] modulo ( 10240 ) ) , \qquad ( EQ 2 - 6 )$$

where SFN is the SFN of the C-DRX on-duration start occasion, subframe_number is the subframe number of the C-DRX on-duration start occasion, timeReferenceSFN and timeDomainOffset are used to indicate the first (1^{st}) C-DRX on duration start occasion; drx−periodicity is the (non-integer or fractional) periodicity of the C-DRX; and N is an integer greater than or equal to 0.

In an embodiment, the SFN and the subframe number of the C-DRX on-duration start occasion can be determined by:

$$[ ( SFN \times 10 ) + subframe\_number ] = ceil ( [ {SFN}_{starttime} \times 10 + {subframe}_{starttime} + N \times ( drx - periodicity ) ] modulo ( 10240 ) ) , \qquad ( EQ 2 - 7 )$$

where SFN_{start time} and subframe_{start time} are respectively the SFN and subframe number of the first (1^{st}) C-DRX on-duration start occasion; drx−periodicity is the (non-integer or fractional) periodicity of the C-DRX; and N is an integer greater than or equal to 0. In an embodiment, the SFN_{start time} and subframe_{start time} are indicated explicitly when/if the C-DRX is activated.

In the present disclosure, the floor(X) is a function of determining/acquiring/calculating the maximal integer that is less than or equal to X. The floor( ) may be removed from each of formula EQ 2-1 to EQ 2-5 if the C-DRX periodicity value is configured as an integer.

In the present disclosure, the ceil(X) is a function of determining/acquiring/calculating the minimum integer that is greater than or equal to X. The ceil( ) may be removed from the formula/equation EQ 2-6 or EQ 2-7 if the C-DRX periodicity value is configured as an integer.

In an embodiment, the above formula/equation of determining the time-domain position (e.g., SFN, subframe number, symbol number, slot number) of the C-DRX on-duration start occasion may be used to determine the resource occasion of the CG and/or SPS.

### The First (1^{st}) DRX On-Duration Start Occasion Determination

When determining the C-DRX on duration start occasion, the UE may need to determine the 1^{st} occasion when the C-DRX is activated/re-configured or the time-domain position (e.g., the SFN_{start time} and subframe_{start time}) of the first (1^{st}) C-DRX on-duration start occasion (e.g., to determine the occasion where m=0 or N=0 in the formula/equation EQ 2-1 to EQ 2-5 and EQ 2-7).

In some embodiments, the C-DRX is (re-)configured or activated by a dedicated RRC (radio resource control) signaling and the dedicated RRC signaling may be retransmitted. Upon the reception of the dedicated RRC signaling, the UE is difficult to decide the occasion when the C-DRX is activated or the time-domain position (e.g., SFN_{start time}, and/or slot_{start time} and/or symbol_{start time}) of the first (1^{st}) C-DRX on-duration start occasion. For example, at a H-SFN (hyper SFN) boundary (e.g., SFN=1023 or SFN=0), the UE may be hard to determine the dedicated RRC signaling is first transmitted in which H-SFN.

In an embodiment, hsfn-LSB-Info with/having one bit is configured to the UE, to indicate the LSB (least significant bit) of the H-SFN corresponding to the SFN of the first transmission of the dedicated RRC signaling containing C-DRX (re-)configuration and/or activation.

As an alternative or in addition, SFN_{start time}, and/or subframe_{start time} and/or slot_{start time} and/or symbol_{start time} of the first (1^{st}) on-duration start occasion is explicitly configured to indicate the starting SFN, and/or starting subframe, and/or starting slot and/or starting symbol of the 1^{st} C-DRX on-duration start occasion.

In this embodiment, the dedicated RRC signaling (re-)transmission comprising the C-DRX (re-)configuration (information) may not cost more than 1024 ms.

In an embodiment, the timeReferenceSFN is configured to indicate the closest SFN preceding or after the reception of the dedicated RRC signaling comprising the C-DRX (re-)configuration, or to indicate the closest SFN preceding or after the first (1^{st}) transmission of the dedicated RRC signaling comprising the C-DRX (re-)configuration and/or activation. The timeReferenceSFN is used for determining the H-SFN of the C-DRX first onDuration start time (e.g., the start time of the 1^{st} C-DRX on-duration start occasion), or the closest SFN preceding or after the 1^{st} C-DRX on-duration start occasion (e.g., the case with m=0 in the formulas EQ 2-1 to EQ 2-5, or N=0 in the formulas EQ 2-6 and EQ 2-7).

In an embodiment, timeDomainOffset and timeReferenceSFN are configured to indicate the 1^{st} C-DRX on-duration start occasion, wherein:
the timeReferenceSFN indicates a reference SFN used for determining a start time of the 1^{st} C-DRX on-duration start occasion.
the timeDomainOffset indicates an offset between the reference SFN and the 1^{st} C-DRX on-duration start occasion.

For example, the 1^{st} C_DRX first onDuration starts at the SFN and subframe occasion which is:
the closest timeReferenceSFN boundary (e.g., SFN start or end occasion) preceding or after the reception of (the RRC signaling comprising) the C-DRX configuration minus the timeDomainOffset or
the closest timeReferenceSFN boundary (e.g., SFN start or end occasion) after the reception of (the RRC signaling comprising)) the C-DRX configuration plus the timeDomainOffset.

In an embodiment, the dedicated RRC signaling (re-)transmission does not cost more than a value step of the timeReferenceSFN.

The embodiment of configuring the timeDomainOffset and the timeReferenceSFN to indicate the 1^{st} C-DRX on-duration start occasion may be applied for the EQ 2-2 and EQ 2-6.

In an embodiment, drx-Periodicity, drx-StartOffset and timeReferenceSFN are configured to indicate the 1^{st} C-DRX on-duration start occasion, wherein:
the timeReferenceSFN indicates a reference SFN used for determination the H-SFN of the C_DRX first onDuration start time or the closest SFN preceding or after the 1^{st} C-DRX on-duration start occasion (e.g., m=0 in the formula EQ 2-3), and
drxOffset and drxPeriodicity are used to determine the SFN and subframe of C_DRX onduration start time (see, e.g., EQ 2-3).

In an embodiment, the dedicated RRC signaling (re-)transmission will not cost more than the value step of timeReferenceSFN.

### CG HARQ Process Number Determination

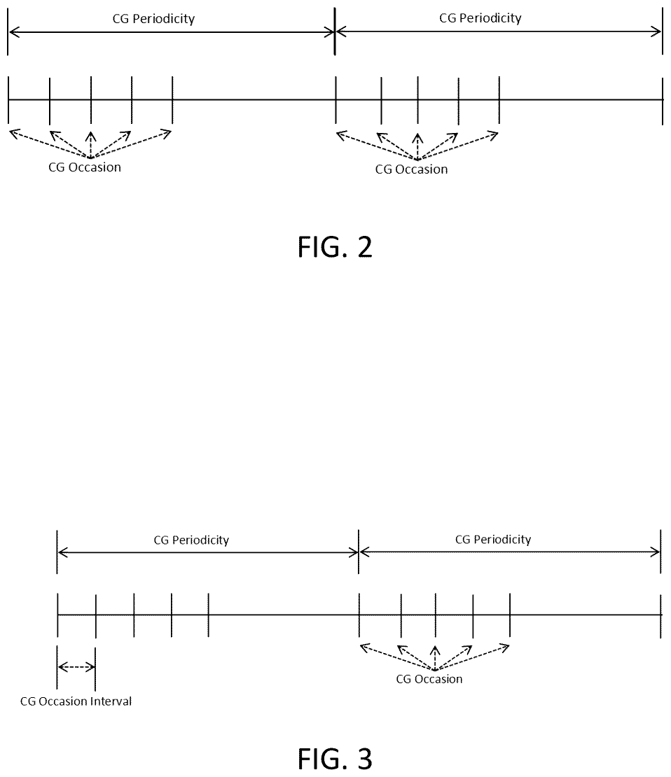

In some embodiments, for a UL burst transmission with a large burst size or a UL burst transmission with burst arrive time jitter, multiple CG occasions in one CG period may be configured. For example, each CG periodicity shown in FIG. 2 comprises 5 CG occasions. Note that the CG periodicity can also be a C-DRX periodicity.

In an embodiment, the CG occasion is called CG resource occasion.

For the case of multiple CG occasions being in one CG period, the HARQ process ID can be determined by one of the following embodiments.

In an embodiment, a HARQ process ID range is configured for the CG. The UE selects a HARQ process ID from the HARQ process ID range for a CG occasion and indicates the selected the HARQ process ID to gNB (e.g., BS) along with UL transmissions over this CG resource occasion (e.g., via CG-UCI (CG UL control information), or subCG-UCI). In this embodiment, the UE can autonomously perform the re-transmission for a certain HARQ process with available UL resources (e.g., CG resources or UL grant scheduled by the gNB). If/When there is no UL data transmission on a CG occasion, the UE sends an indication of no UL data transmission to the gNB on the CG occasion so that the gNB can differentiate the case of the UL transmission failure and the case of no UL data transmission. When there is no UL information received on the CG occasion, the gNB may assume that an UL transmission failure occurred and schedule a UL grant without the HARQ process ID assigned for a UL re-transmission.

In an embodiment, the HARQ process ID range is configured for the CG. The HARQ process ID is determined per CG periodicity (e.g., multiple CG occasions in one CG period share the same HARQ process ID). For example, the HARQ process ID may be determined by:

$$HARQ process ID = [ floor ( CURRENT\_SYMBOL / periodicity ) ] modulo ( nrofHARQ - Processes ) + ( harq - ProcID - Offset )$$

where CURRENT_{SYMBOL}=(SFN×numberOfSlotsPerFrame×numberOfSymbolsPerSlot)+slot_{number}×numberOfSymbolsPerSlot+symbol_number, where numberOfSlotsPerFrame is the number of consecutive slots per frame, numberOfSymbolsPerSlot is the number of consecutive symbols per slot, nrofHARQ−Processes is a number of HARQ process IDs configured for the plurality of CG resource occasions, and harq−ProcID−Offset is a 1st HARQ process ID configured for the plurality of CG resource occasions

In an embodiment, the HARQ process ID range is configured for the CG. The HARQ process ID is determined per CG occasion during the CG periodicity (or during the C-DRX periodicity). For instance, the HARQ process ID may be determined by:

$$HARQ process ID = [ floor ( CURRENT\_SYMBOL /$$

$$CG\_occasion \_interval ) ] modulo ( nrofHARQ - Processes ) +$$

$$( harq - ProcID - Offset ) where {CURRENT}_{SYMBOL} =$$

$$( SFN \times numberOfSlotsPerFrame \times numberOfSymbolsPerSlot ) +$$

$${slot}_{number} \times numberOfSymbolsPerSlot + symbol\_number , ,$$

numberOfSlotsPerFrame is the number of consecutive slots per frame, numberOfSymbolsPerSlot is the number of consecutive symbols per slot, CG_occasion_interval is an interval between two contiguous CG occasions, nrofHARQ−Processes is a number of HARQ process IDs configured for the plurality of CG resource occasions, and harq−ProcID−Offset is a 1^{st} HARQ process ID configured for the plurality of CG resource occasions. For instance, FIG. 3 shows an example of the interval between two contiguous CG occasions, i.e., CG_occasion_interval.

In an embodiment, the HARQ process ID of a CG occasion is determined based on a sequence number of the CG occasion. For example, the HARQ process ID of the CG occasion may be determined by:

$$HARQ process ID = CG\_occasion \_SequenceNumber modulo ( nrofHARQ - Processes ) + ( harq - ProcID - Offset )$$

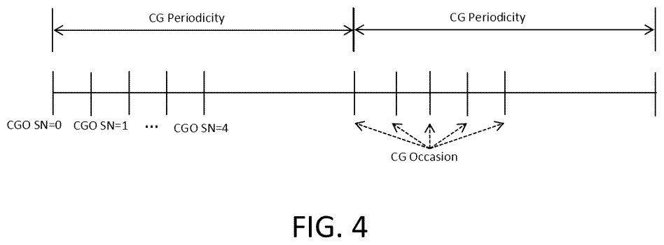

In this embodiment, harq−ProcID−Offset is the start HARQ process ID that the CG can use and nrofHARQ−Processes is a total number of HARQ process IDs that the CG can use. That is the range of HARQ process IDs which can be used for the CG is [harq−procID−offset, . . . , (harq−procID−offset+nrofHARQ−Processes−1)]. In addition, CG_occasion_SequenceNumber is the CG occasion (e.g., one UL grant) sequence number during the CG periodicity (or during the C-DRX periodicity). For instance, the CG_occasion_SequenceNumber for each CG in one CG periodicity may be configured as CGO SNs shown in FIG. 4. Specifically, in FIG. 4, the sequence number of the first CG occasion is 0, the sequence number of the second CG occasion is 1, and so on.

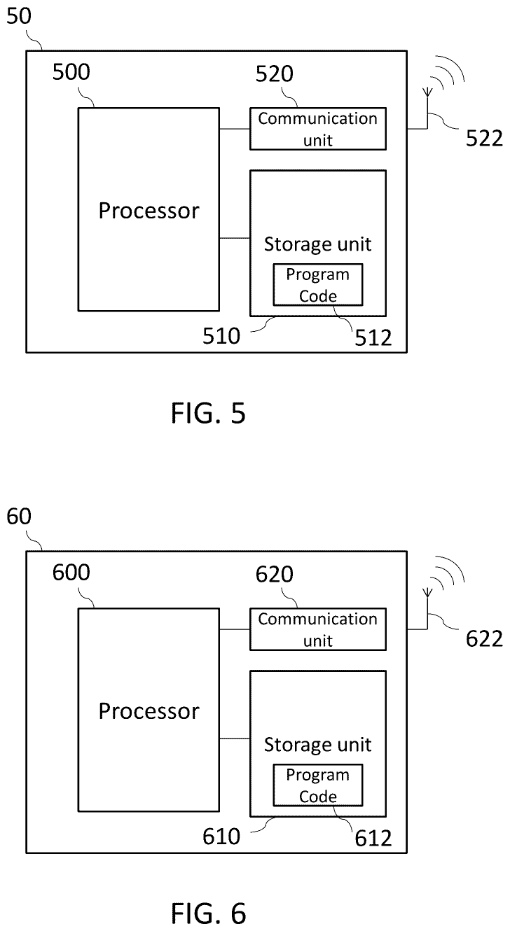

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 510 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g., a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 610 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment or another wireless network node).

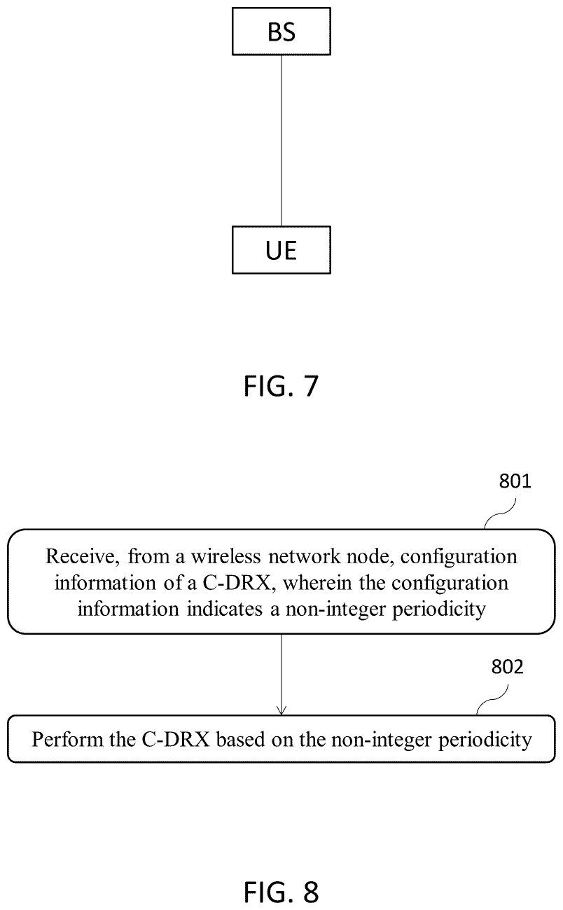

FIG. 7 shows a schematic diagram of a wireless communication system according to an embodiment of the present disclosure. The wireless communication system shown in FIG. 7 comprises a BS and a UE. The BS may transmit configuration information of the C-DRX to the UE and the UE may perform the C-DRX based on the configuration information to receive data (e.g., XR data) from the BS. Note that the communication system may further comprise other network elements (e.g., AMF, SMF and UPF).

FIG. 8 shows a flowchart of a method according to an embodiment of the present procedure. The method may be used in a wireless terminal (e.g., UE) and comprises the following steps:

Step 801: Receive, from a wireless network node, configuration information of a C-DRX, wherein the configuration information indicates a non-integer periodicity.

Step 802: Perform the C-DRX based on the non-integer periodicity.

Based on FIG. 8, the UE receives configuration information of a C-DRX from a wireless network node (e.g., BS, gNB). The configuration information of the C-DRX comprises a integer periodicity. The UE performs the C-DRX based on the non-integer periodicity, e.g., to receive data (e.g., signaling, control information, service data) from the wireless network node.

In an embodiment, the configuration information indicates the fractional periodicity by indicating a fractional value of the fractional periodicity (e.g., 3 per 200 ms, 3 per 100 ms, 9 per 200 ms, 3 per 50 ms, 9 per 125 ms, 9 per 100 ms, or 3 per 25 ms).

In an embodiment, the configuration information indicates the fractional periodicity by indicating a numerator and a denominator.

In an embodiment of performing the C-DRX based on the non-integer periodicity, the wireless terminal determines a C-DRX on duration start occasion based on one of EQ 2-1 to EQ2-7. The detail of EQ 2-1 to EQ2-7 can be referred to above embodiments.

In an embodiment, the configuration information comprises indication information associated with determining the 1^{st} C-DRX on-duration start occasion.

In an embodiment, the indication information comprises a least-significant bit of a hyper system frame number associated with a 1^{st} transmission of a radio resource control signaling comprising the configuration information.

In an embodiment, the indication information comprises a reference system frame number (e.g., timeReferenceSFN) and a time-domain offset (e.g., timeDomainOffset). In this embodiment, the 1^{st} C-DRX on-duration start occasion starts at a time-domain location which is the time-domain offset before or after the reference system frame number.

In an embodiment, the indication information comprises a reference system frame number indicating a closest system frame number preceding or following the 1st C-DRX on-duration start occasion and a start offset indicating a time-domain location of the 1^{st} C-DRX on-duration start occasion based on the closest system frame number.

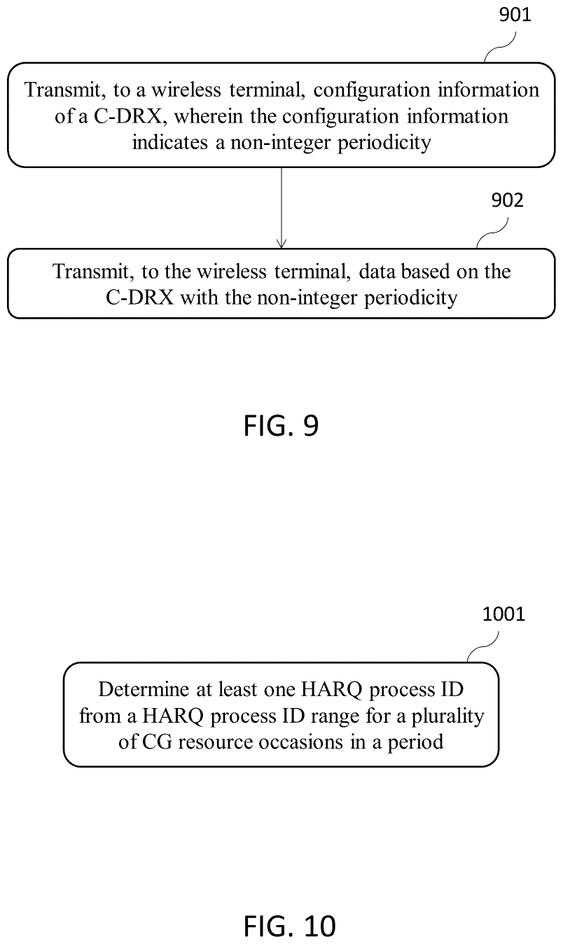

FIG. 9 shows a flowchart of a method according to an embodiment of the present procedure. The method may be used in a wireless network node (e.g., BS) and comprises the following steps:

Step 901: Transmit, to a wireless terminal, configuration information of a C-DRX, wherein the configuration information indicates a non-integer periodicity.

Step 902: Transmit, to the wireless terminal, data based on the C-DRX with the non-integer periodicity.

In FIG. 9, the wireless network node transmits configuration information of a C-DRX to a wireless terminal (e.g., UE). The configuration information comprises indicates a non-integer periodicity. The wireless network node transmits data (e.g., signaling, control information, service data) based on the C-DRX with/having the non-integer periodicity.

In an embodiment, the configuration information indicates the fractional periodicity by indicating a fractional value of the fractional periodicity (e.g., 3 per 200 ms, 3 per 100 ms, 9 per 200 ms, 3 per 50 ms, 9 per 125 ms, 9 per 100 ms, or 3 per 25 ms).

In an embodiment, the configuration information indicates the fractional periodicity by indicating a numerator and a denominator.

In an embodiment of transmitting the data based on the C-DRX with the non-integer periodicity, the wireless network node determines a C-DRX on duration start occasion based on one of EQ 2-1 to EQ2-7. The detail of EQ 2-1 to EQ2-7 can be referred to above embodiments.

In an embodiment, the configuration information comprises indication information associated with determining the 1^{st} C-DRX on-duration start occasion.

In an embodiment, the indication information comprises a least-significant bit of a hyper system frame number associated with a 1^{st} transmission of a radio resource control signaling comprising the configuration information.

In an embodiment, the indication information comprises a reference system frame number (e.g., timeReferenceSFN) and a time-domain offset (e.g., timeDomainOffset). In this embodiment, the 1st C-DRX on-duration start occasion starts at a time-domain location which is the time-domain offset before or after the reference system frame number.

In an embodiment, the indication information comprises a reference system frame number indicating a closest system frame number preceding or following the 1st C-DRX on-duration start occasion and a start offset indicating a time-domain location of the 1^{st} C-DRX on-duration start occasion based on the closest system frame number.

FIG. 10 shows a flowchart of a method according to an embodiment of the present disclosure. The method may be used in a wireless terminal (e.g., UE) or a wireless network node (e.g., BS) and comprises the following step:

Step 1001: Determine at least one HARQ process ID from a HARQ process ID range for a plurality of CG resource occasions in a period.

In FIG. 10, the wireless terminal or a wireless network node determines HARQ process ID(s) from a HARQ process ID range for a plurality of CG resource occasions in a period. Based on the determined HARQ process ID, the wireless terminal or a wireless network node is able to perform the HARQ process to retransmit data because of communication failure.

In an embodiment, the HARQ process ID is determined per CG resource occasion. In this embodiment, the wireless terminal transmits indication of the determined at least one HARQ process ID along with uplink transmissions over the CG resource occasions to the wireless network node.

In an embodiment, the HARQ process ID is determined per period.

In an embodiment, the HARQ process ID is determined by:

$$HARQ process ID = [ floor ( CURRENT\_SYMBOL / periodicity ) ] modulo ( nrofHARQ - Processes ) + ( harq - ProcID - Offset ) , \\ wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, nrofHARQ−Processes is a number of HARQ process IDs configured for the plurality of CG resource occasions, and harq−ProcID−Offset is a 1^{st} HARQ process ID configured for the plurality of CG resource occasions.

In an embodiment, the HARQ process ID is determined per transmission over the CG resource occasions.

In an embodiment, the HARQ process ID is determined by:

$$HARQ process ID =$$

$$[ floor ( CURRENT\_SYMBOL / CG\_occasion \_interval ) ]$$

$$modulo ( nrofHARQ - Processes ) + ( harq - ProcID - Offset ) ,$$

$$wherein {CURRENT}_{SYMBOL} = ( SFN \times numberOfSlotsPerFrame \times numberOfSymbolsPerSlot ) + {slot}_{number} \times numberOfSymbolsPerSlot + symbol\_number ,$$

where numberOfSlotsPerFrame is the number of consecutive slots per frame, numberOfSymbolsPerSlot is the number of consecutive symbols per slot, CG_occasion_interval is an interval between two contiguous CG occasions, nrofHARQ−Processes is a number of HARQ process IDs configured for the plurality of CG resource occasions, and harq−ProcID−Offset is a 1^{st} HARQ process ID configured for the plurality of CG resource occasions.

In an embodiment, the HARQ process ID of a first CG occasion in the plurality of CG occasions is determined based on a sequence number of the first CG occasion.

In an embodiment, the HARQ process ID is determined by:

$$HARQ process ID =$$

$$[ floor ( CURRENT\_SYMBOL / CG\_occasion \_interval ) ]$$

$$modulo ( nrofHARQ - Processes ) + ( harq - ProcID - Offset ) ,$$

wherein CURRENT_{SYMBOL}=(SFN×numberOfSlotsPerFrame×numberOfSymbolsPerSlot)+slot_{number}×numberOfSymbolsPerSlot+symbol_number, where CG_occasion_SequenceNumber is the sequence number, nrofHARQ−Processes is a number of HARQ process IDs configured for the plurality of CG resource occasions, and harq−ProcID−Offset is a 1st HARQ process ID configured for the plurality of CG resource occasions.

In an embodiment, the period is a CG occasion period or a C-DRX period.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the wireless communication method comprising:
receiving, from a wireless network node, configuration information of a connected mode discontinuous reception (C-DRX), wherein the configuration information indicates a non-integer periodicity, and
determining a C-DRX on-duration start occasion based on the non-integer periodicity.

2. The wireless communication method of claim 1, wherein the configuration information indicates the fractional periodicity by indicating a fractional value of the fractional periodicity.

3. The wireless communication method of claim 1, wherein the C-DRX on-duration start occasion is determined based on:
floor([((1024×m+SFN)×10)+subframe_number]modulo(drx−periodicity))=drx−StartOffset, wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.

4. The wireless communication method of claim 1, wherein a drx-Periodicity, a drx-StartOffset and a timeReferenceSFN are configured to indicate the C-DRX on-duration start occasion.

5. The wireless communication method of claim 4, wherein the timeReferenceSFN indicates a reference system frame number (SFN) used for determination a Hyper SFN (H-SFN) of the C-DRX on-duration start occasion or the closest SFN preceding or after the C-DRX on-duration start occasion.

6. The wireless communication method of claim 4, wherein the drx-StartOffset and the drx-Periodicity are used to determine a SFN and a subframe of the C-DRX on-duration start occasion.

7. A wireless communication method for use in a wireless network node, the method comprising:
transmitting, to a wireless terminal, configuration information of a connected mode discontinuous reception (C-DRX), wherein the configuration information indicates a non-integer periodicity, and
transmitting, to the wireless terminal, data based on a C-DRX on-duration start occasion with the non-integer periodicity.

8. The wireless communication method of claim 7, wherein the configuration information indicates the fractional periodicity by indicating a fractional value of the fractional periodicity.

9. The wireless communication method of claim 7, wherein the C-DRX on-duration start occasion is determined based on:
floor([((1024×m+SFN)×10)+subframe_number]modulo(drx−periodicity))=drx−StartOffset, wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.

10. The wireless communication method of any of claim 7, a drx-Periodicity, a drx-StartOffset and a timeReferenceSFN are configured to indicate the C-DRX on-duration start occasion.

11. The wireless communication method of claim 10, wherein:
the timeReferenceSFN indicates a reference system frame number (SFN) used for determination a Hyper SFN (H-SFN) of the C-DRX on-duration start occasion or the closest SFN preceding or after the C-DRX on-duration start occasion; and/or
the drx-StartOffset and the drx-Periodicity are used to determine a SFN and a subframe of the C-DRX on-duration start occasion.

12. A wireless terminal, comprising:
a communication unit, configured to receive, from a wireless network node, configuration information of a connected mode discontinuous reception (C-DRX), wherein the configuration information indicates a non-integer periodicity, and
a processor configured to determine a C-DRX on-duration start occasion based on the non-integer periodicity.

13. The wireless terminal of claim 12, wherein the configuration information indicates the fractional periodicity by indicating a fractional value of the fractional periodicity.

14. The wireless terminal of claim 12, wherein the C-DRX on-duration start occasion is determined based on:
floor([((1024×m+SFN)×10)+subframe_number]modulo(drx−periodicity))=drx−StartOffset, wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.

15. The wireless terminal of claim 12, wherein a drx-Periodicity, a drx-StartOffset and a timeReferenceSFN are configured to indicate the C-DRX on-duration start occasion.

16. The wireless terminal of claim 15, wherein the timeReferenceSFN indicates a reference system frame number (SFN) used for determination a Hyper SFN (H-SFN) of the C-DRX on-duration start occasion or the closest SFN preceding or after the C-DRX on-duration start occasion.

17. The wireless terminal of claim 15, wherein the drx-StartOffset and the drx-Periodicity are used to determine a SFN and a subframe of the C-DRX on-duration start occasion.

18. A wireless network node, comprising a communication unit, wherein the communication unit is configured to perform the wireless communication method of claim 7.

19. The wireless network node of claim 18, wherein the configuration information indicates the fractional periodicity by indicating a fractional value of the fractional periodicity.

20. The wireless network node of claim 18, wherein the C-DRX on-duration start occasion is determined based on:
floor([((1024×m+SFN)×10)+subframe_number]modulo(drx−periodicity))=drx−StartOffset, wherein m=0 when the C-DRX is activated and is incremented every time SFN=0, SFN is the system frame number of the C-DRX on-duration start occasion, subframe_number is a subframe number of the C-DRX on-duration start occasion, drx−periodicity is the non-integer periodicity, and drx−StartOffset is indicated in the configuration information of the C-DRX.
